(19) United States
(12) Patent Application Publication
(10) Pub. No.: US 2002/0191777 A1
(43) Pub. Date: Dec. 19, 2002

(54) Twisted pair termination using vacuum microelectronic circuitry

(75) Inventors: Celite Milbrandt, Austin, TX (US); Basil Horangic, Austin, TX (US)

Correspondence Address: Gary W. Hamilton, P.O. Box 203518, Austin, TX, 78720, US

(73) Assignee: Celite Systems

(21) Appl. No.: 10/153,148

(22) Filed: May 22, 2002

Related U.S. Application Data
(60) Provisional application No. 60/293,817, filed on May 25, 2001.

(51) Int. Cl. H04M 11/00; H04M 9/00

(52) U.S. Cl. 379/387.01; 379/93.05

(57) ABSTRACT

Twisted pair termination using vacuum microelectronic circuitry. The invention is operable to increase greatly the number of subscriber lines to access any number of networks. Certain aspects of the invention employ vacuum microelectronic circuitry that offers a dramatic increase in matrix switch density compared with other technologies. The invention includes a reconfigured/modified version of vacuum microelectronic circuitry to perform any number of applications towards which such technology is not currently directed including line driving, voltage stepping, amplification, impedance matching, filtering, and over-voltage/surge protection including lightning protection. The present implementations of vacuum microelectronic circuitry are primarily directed towards performing large amounts of matrix switching, sometimes on the order of servicing 1500×1500 matrices. In certain embodiments of the invention, the matrix size is dramatically reduced to 300×50, as optimally designed to accommodate and service the particular physical constraints including board and interface real estate, system impedances, and multiplexing limitations for various technologies.

### BACKGROUND

1. Technical Field

The invention relates generally to vacuum microelectronic circuitry implementations; and, more particularly, it relates to implementations of vacuum microelectronic circuitry that is used to perform twisted pair termination applications.

2. Related Art

Conventional approaches to provide varying services to subscribers are geared towards physical provision of hardware on a customer by customer basis. For example, in the context of providing digital subscriber line (DSL) service to a new customer, a common approach is to first disconnect any existing service to that customer, then performing a re-connect to a plain old telephone service/system (POTS) chassis, then connecting the POTS chassis to a DSL enabled modem, and finally connecting the POTS chassis to a class 5 switch. Each and every one of these functions requires a re-configuration of hardware to meet this customer's new needs. This can prove extremely costly in terms of man hours and hardware. Even changing from a relatively higher end service such as integrated services digital network (ISDN) to digital subscriber line (DSL) service also requires this physical re-configuration for provision of the new service. There does not exist in the art an integrated system to avoid this manual reconfiguration between various services.

Moreover, the current state of many conventional switching technologies prohibits their implementation within central offices and/or switching stations, given their large size and extremely high consumption of real estate within the circuitries and boards employed to perform such applications.

In addition, the conventional implementations that employ discrete components to perform a variety of functions including lightning protection, transformer functions, analog front end, and line driver functions using discrete solid state devices inherently leads to a low density of components on a given board or within a given application. The conventional approach of physically re-configuring the system to accommodate the various services to be provided within a substantially diverse customer base inherently leads to this disjointed and discrete device implementation approach.

A fundamental drawback of active electronic devices based on silicon is that electron transport is impeded by the silicon crystal lattice, which places a limit on both the miniaturization and the switching speed of such devices. A solution to this is to create an active electronic device which relies on electron transport through vacuum. Such devices come under the umbrella of a field of microelectronics known as vacuum microelectronics, the interest in which has grown greatly over the last few years, largely fed by the prospect of their use to make flat-screen displays.

Integrated vacuum microelectronic triodes have been fabricated on silicon using micromaching to yield an emitting cathode tip made from silicon which lies beneath a self-aligned gate and anode. The anode electrode is suspended across the emitting tip, and the gate approaches from the sides; both are supported on an insulating layer of thick silicon dioxide. The device operates in the normally-on mode: the anode is biased positively until a large stable emission current is obtained, and the gate is biased negatively to turn the device off. D.M. Garner and G. A. J. Amaratunga, “VACUUM MICROELECTRONIC DEVICES,” Department of Engineering, University of Cambridge.

Further limitations and disadvantages of conventional and traditional systems will become apparent to one of skill in the art through comparison of such systems with the invention as set forth in the remainder of the present application with reference to the drawings.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a subscriber network that is built in accordance with certain aspects of the invention.

FIG. 2 is a system diagram illustrating an embodiment of a multi-service access platform (MSAP) system that is built in accordance with certain aspects of the invention.

FIG. 3 is a system diagram illustrating an embodiment of a digital signal processing system that is built in accordance with certain aspects of the invention.

FIG. 4A is a system diagram illustrating an embodiment of asymmetric digital subscriber line (ADSL) adapted filtering circuitry that is built in accordance with certain aspects of the invention.

FIG. 4B is a system diagram illustrating an embodiment of plain old telephone service/system (POTS) adapted filtering circuitry that is built in accordance with certain aspects of the invention.

FIG. 5A is a system diagram illustrating an embodiment of very high speed asymmetric digital subscriber line (VDSL) adapted filtering circuitry that is built in accordance with certain aspects of the invention.

FIG. 5B is a system diagram illustrating an embodiment of plain old telephone system (POTS) and asymmetric digital subscriber line (ADSL) adapted filtering circuitry that is built in accordance with certain aspects of the invention.

FIG. 6 is a system diagram illustrating an embodiment of a vacuum microelectronic circuitry multi-service access platform (MSAP) system that is built in accordance with certain aspects of the invention.

FIG. 7 is a system diagram illustrating an embodiment of a vacuum microelectronic circuitry multi-service access platform (MSAP) system that is built in accordance with certain aspects of the invention.

FIG. 8 is a system diagram illustrating another embodiment of a vacuum microelectronic circuitry multi-service access platform (MSAP) system that is built in accordance with certain aspects of the invention.

FIG. 9 is a system diagram illustrating another embodiment of a vacuum microelectronic circuitry multi-service access platform (MSAP) system that is built in accordance with certain aspects of the invention.

FIG. 10 is a system diagram illustrating another embodiment of a vacuum microelectronic circuitry multi-service access platform (MSAP) system that is built in accordance with certain aspects of the invention.

FIG. 11 is a system diagram illustrating another embodiment of a vacuum microelectronic circuitry multi-service access platform (MSAP) system that is built in accordance with certain aspects of the invention.

FIG. 12 is a system diagram illustrating another embodiment of a vacuum microelectronic circuitry multi-service access platform (MSAP) system that is built in accordance with certain aspects of the invention.

FIG. 13 is a system diagram illustrating another embodiment of a vacuum microelectronic circuitry multi-service access platform (MSAP) system that is built in accordance with certain aspects of the invention.

FIG. 14A is a functional block diagram illustrating an embodiment matrix switching operation that is performed in accordance with certain aspects of the invention.

FIG. 14B is a functional block diagram illustrating an embodiment matrix switching operation that is performed in accordance with certain aspects of the invention.

FIG. 14C is a functional block diagram illustrating an embodiment matrix switching operation that is performed in accordance with certain aspects of the invention.

### DETAILED DESCRIPTION OF THE INVENTION

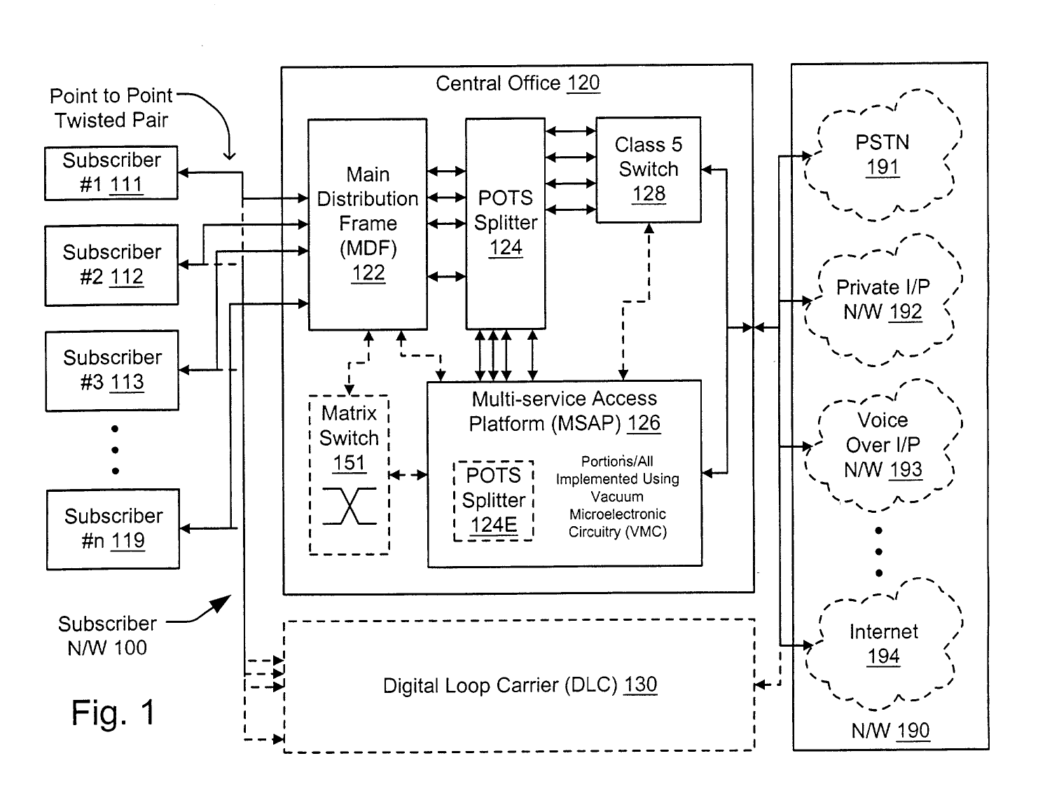

FIG. 1 is a system diagram illustrating an embodiment of a subscriber network 100 that is built in accordance with certain aspects of the invention. The subscriber network 100 is operable to provide service to any indefinite number of subscribers, shown as a subscriber #1 111, a subscriber #2 112, a subscriber #3 113, . . . , and a subscriber #n 119. Each of the subscriber #1 111, the subscriber #2 112, the subscriber #3 113, . . . , and the subscriber #n 119 is able to service a point to point twisted pair connection to a central office 120. A subscriber connection to the central office 120 is made using a conventional telephone line in certain embodiments of the invention. Moreover, and alternatively, each of the subscriber #1 111, the subscriber #2 112, the subscriber #3 113, . . . , and the subscriber #n 119 is able to service a connection to a digital loop carrier (DLC) 130 in even other embodiments.

The central office 120 includes a main distribution frame (MDF) 122 to which each of the subscriber #1 111, the subscriber #2 112, the subscriber #3 113, . . . , and the subscriber #n 119 first connects within the central office 120. The central office 120 also includes a plain old telephone system (POTS) splitter 124 to which each of the various subscribers is able to connect via the MDF 122. In certain embodiments of the invention, the POTS splitter is operable to perform frequency division of the incoming spectrum for various applications. As will be seen in some of the other various applications, the filtering that may be performed in various embodiments of the invention can differ greatly, yet the totality of the invention is operable to accommodate any and all of a variety of filtering needs (including frequency division multiplexing) as required by particular applications. Then, the central office 120 also includes a class 5 switch 128, known to those having skill in the art, that allows also for point to point connectivity from any one of the subscribers. The class 5 switch 128 is operable to provide connectivity externally from the central office 120 to a network 190.

In addition, the POTS splitter 124 provides for point to point connectivity to a multiservice access platform (MSAP) 126. As may be deduced in various embodiments of the invention, one particular embodiment of an MSAP, without departing from the scope and spirit of the invention, includes a digital subscriber line access multiplexor (DSLAM). However, the terminology MSAP is more appropriate for certain embodiments of the invention given the novel and improved functionality offered therein. The MSAP 126 is also operable to provide connectivity externally from the central office 120 to a network 190.

The network 190 is shown as having any of a number of various networks. Any of the subscribers is able to access one or more, or all, of the various networks shown within the network 190 in certain embodiments of the invention. In other embodiments, a subscriber may only wish to access one network. Exemplary networks within the network 190 are shown as a public switch(ed) telephone (PSTN) network 191, a private Internet protocol (I/P) network 192, a voice over Internet protocol (VoIP) network 193, . . . , and the Internet 194 itself. The shown networks 191, 192, 193, . . . , and 194 do not comprise an exclusive list, and a person having skill in the art will recognize that any number of different networks, each being accessible through an embodiment of a central office, is included within the scope and spirit of the invention.

In alternative embodiments, the MSAP 126 also includes a POTS splitter 124E. The functionality offered by the POTS splitter 124E may include exactly the same functionality offered by the POTS splitter 124. The POTS splitter 124E may be employed in place of, or in conjunction with, the POTS splitter 124 as well. Moreover, in alternative embodiments, a matrix switch 151 is included within the central office 151 to perform switching between the various subscribers and the various networks and services that they seek to solicit. The functionality of matrix switching may alternatively be performed in other locations within the central office 120, including within various locations within the MSAP 126, as will be seen below in various embodiments of the invention.

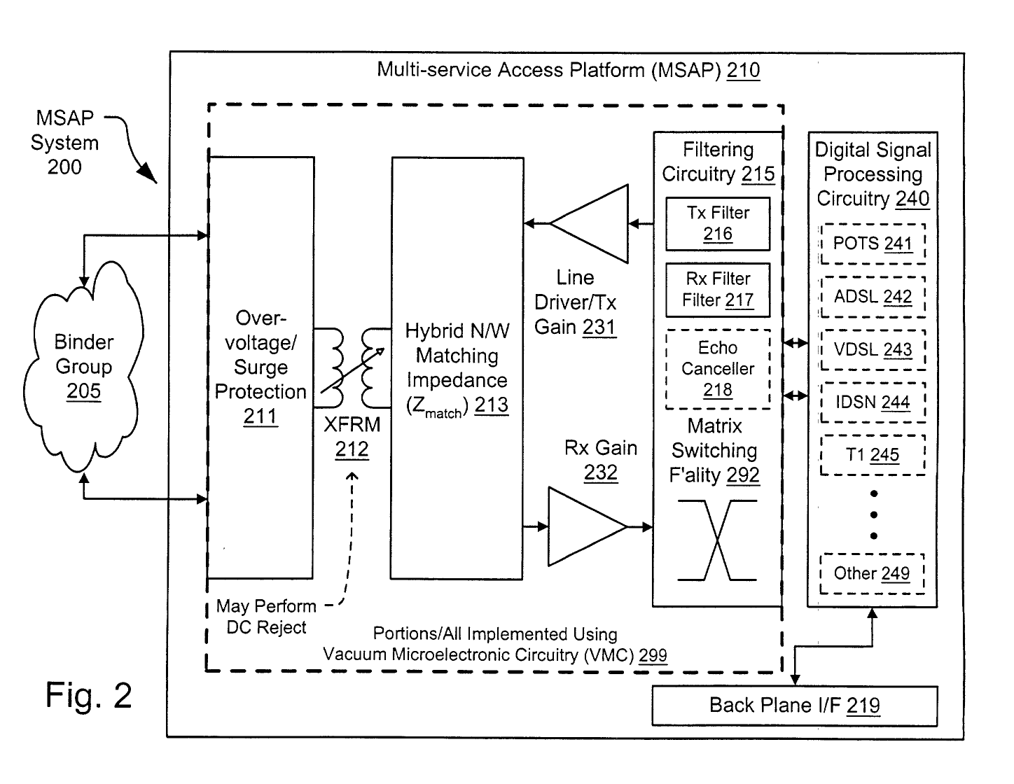

FIG. 2 is a system diagram illustrating an embodiment of a multi-service access platform (MSAP) system 200 that is built in accordance with certain aspects of the invention. The MSAP system 200 includes a binder group 205 that may include a number of subscriber lines. The particular number of subscriber lines included within the binder group 205 is variable in certain instances, and the scalability of the invention is operable to accommodate any of the various number of subscriber lines. The binder group is shown as interfacing with a multi-service access platform (MSAP) 210. From certain perspectives, the MSAP 210 may be viewed as being located within a central office. Alternatively, it may be viewed as being within a digital loop carrier (DLC) in other embodiments.

The MSAP 210 includes circuitry operable to perform over-voltage/surge protection 211. The functionality offered by the over-voltage/surge protection 211 includes lightning protection, protection from over-rated voltage getting on the system, and protection against surges of overrated current as well. The over-voltage/surge protection 211 interfaces with a transformer (XFRM) 212. The XFRM 212 is operable to perform DC rejection of any of the inputs contained within the binder group 205. Alternatively, any requisite DC rejection or other filtering may also be performed in other areas within the MSAP 210 as well.

The XFRM 212 interfaces with circuitry operable to provide a hybrid network matching impedance (Z_{match}) 213. The hybrid network matching impedance (Z_{match}) 213 is operable to perform impedance matching of the network to ensure maximum power and signal throughput, among other benefits of providing impedance matching between the network and the MSAP 210. The hybrid network matching impedance (Z_{match}) 213 interfaces for both up-stream and downstream throughput. The up-stream flow may be accommodated by a possible receiver (Rx) gain 232, and the down-stream flow is handled by a line driver/transmitter (Tx) gain 231. Each of the Rx gain 232 and the line driver/Tx gain 231 is communicatively coupled to filtering circuitry 215. The filtering circuitry 215 is operable perform filtering for both the transmit (down-stream) and receive (up-stream) paths, as shown by a Tx filter 216 and a Rx filter 217. Moreover, the filtering circuitry 215 may also include an optional echo canceller 218. As mentioned above, and as will be described in even more detail below in various embodiments of the invention, the particular filtering that is to be performed for each of the potential services and networks that is to be accessed may various from application to application. In addition, the filtering circuitry 215 provides for matrix switch functionality 292. The matrix switch functionality 292 is operable to perform switching between the various subscribers and the various networks and services that they seek to solicit.

The filtering circuitry 215 communicatively couples to digital signal processing circuitry 240. There are any number of various circuitries that may be included within the digital signal processing circuitry 240, and a subscriber may access any one, any combination, or all of the various circuitries contained therein. Exemplary digital signal processing circuitries 240 includes a plain old telephone system (POTS) digital signal processing circuitry 241, an asymmetric digital subscriber line (ADSL) digital signal processing circuitry 242, a very high speed asymmetric digital subscriber line (VDSL) digital signal processing circuitry 243, an integrated services digital network (ISDN) digital signal processing circuitry 244, a telephony (1.544 Mbps [telephony], one of the basic signalling systems 24×64 Kb) and/or terrestrial 1 [data] T1 digital signal processing circuitry 245, . . . , or any other digital signal processing circuitry 249. The digital signal processing circuitry 240 then communicatively couples to a back plane interface (I/F) 219. The back plane interface (I/F) 219 is operable to communicatively couple to a network interface card or any other network interface circuitry that is operable to enable the MSAP is properly interfaced and communicatively couple to a network. Alternatively, the back plane interface (I/F) 219 itself may be designed to include network interfacing circuitry, thereby obviating the need of an additional network interface card between the back plane interface (I/F) 219 and the network to which it is communicatively coupling.

The invention allows for any of a number of circuitries within the MSAP 210 to be employed using vacuum microelectronic circuitry as known by those persons having skill in the art. Any one, any combination, or all of the portions 299 may be implemented using vacuum microelectronic circuitry without departing from the scope and spirit of the invention. Particular embodiments are described below, yet those persons having skill in the art will recognize that even those embodiments, of certain combinations and permutations not explicitly shown in the various Figures, may be achieved using vacuum microelectronic circuitry within the scope and spirit of the invention.

For example, any one, any combination, and/or all of the circuitry operable to perform over-voltage/surge protection 211, the XFRM 212, the circuitry operable to provide a hybrid network matching impedance (Z_{match}) 213, each of the line driver/Tx gain 231, the Rx gain 232, the filtering circuitry 215 including the Tx filter 216, the Rx filter 217, and the matrix switching functionality 292 may be implemented using the vacuum microelectronic circuitry in accordance with certain aspects of the invention. Similarly, any one, any combination, and/or all of the circuitry operable to perform over-voltage/surge protection 211, the XFRM 212, the circuitry operable to provide a hybrid network matching impedance (Z_{match}) 213, each of the line driver/Tx gain 231, the Rx gain 232, the filtering circuitry 215 including the Tx filter 216, the Rx filter 217, and the matrix switching functionality 292 may also be implemented using solid state technologies. Those having skill in the art will recognize that the scope and spirit of the invention includes the various combinations of devices having portions of vacuum microelectronic circuitry and also solid state circuitries.

Upon reviewing the various embodiments of the invention disclosed within this patent application, those persons having skill in the art will recognize that many of the various functionality devices within the MSAP system 200 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

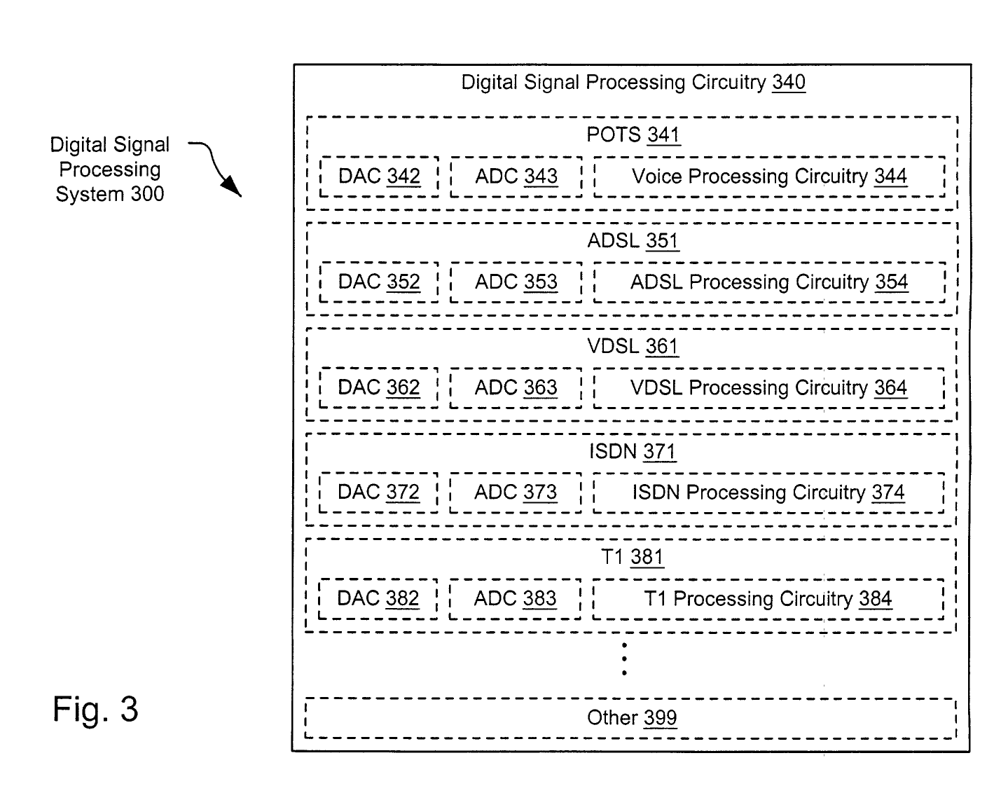

FIG. 3 is a system diagram illustrating an embodiment of a digital signal processing system 300 that is built in accordance with certain aspects of the invention. The digital signal processing system 300 includes digital signal processing circuitry 310. In accordance with the invention, the digital signal processing circuitry 310 may include any number of digital signal processing circuitry including a plain old telephone system (POTS) digital signal processing circuitry 341, an asymmetric digital subscriber line (ADSL) digital signal processing circuitry 351, a very high speed asymmetric digital subscriber line (VDSL) digital signal processing circuitry 361, an integrated services digital network (ISDN) digital signal processing circuitry 371, a telephony (1.544 Mbps [telephony], one of the basic signaling systems 24×64 Kb) and/or terrestrial 1 [data] T1 digital signal processing circuitry 381, . . . , or any other digital signal processing circuitry 399.

Each of the various digital signal processing circuitries may contain its dedicated digital to analog converter (DAC) and analog to digital converter (ADC) as well as dedicated processing circuitry to perform its requisite functionality. Those persons having skill in the art will recognize that some of the various services and network to be accessed using the digital signal processing circuitry 340 may require different sampling rates, resolution, and other parameters particular to the given service and/or application to be accessed.

In light of this consideration, the plain old telephone system (POTS) digital signal processing circuitry 341 is shown as having a DAC 342, an ADC 343, and a voice processing circuitry 344. Similarly, the asymmetric digital subscriber line (ADSL) digital signal processing circuitry 351 is shown as having a DAC 352, an ADC 353, and an asymmetric digital subscriber line (ADSL) processing circuitry 354. The very high speed asymmetric digital subscriber line (VDSL) digital signal processing circuitry 361 is shown as having a DAC 362, an ADC 363, and a very high speed asymmetric digital subscriber line (VDSL) processing circuitry 344. The integrated services digital network (ISDN) digital signal processing circuitry 371 is shown as having a DAC 372, an ADC 373, and an integrated services digital network (ISDN) processing circuitry 374. The telephony (1.544 Mbps [telephony], one of the basic signaling systems 24×64 Kb) and/or terrestrial 1 [data] T1 digital signal processing circuitry 381 is shown as having a DAC 382, an ADC 383, and a T1 processing circuitry 344.

Similarly, the other digital signal processing circuitry 399 may also include a DAC, an ADC, and a dedicated processing circuitry to facilitate the operation and services of the other digital signal processing circuitry 399 as well.

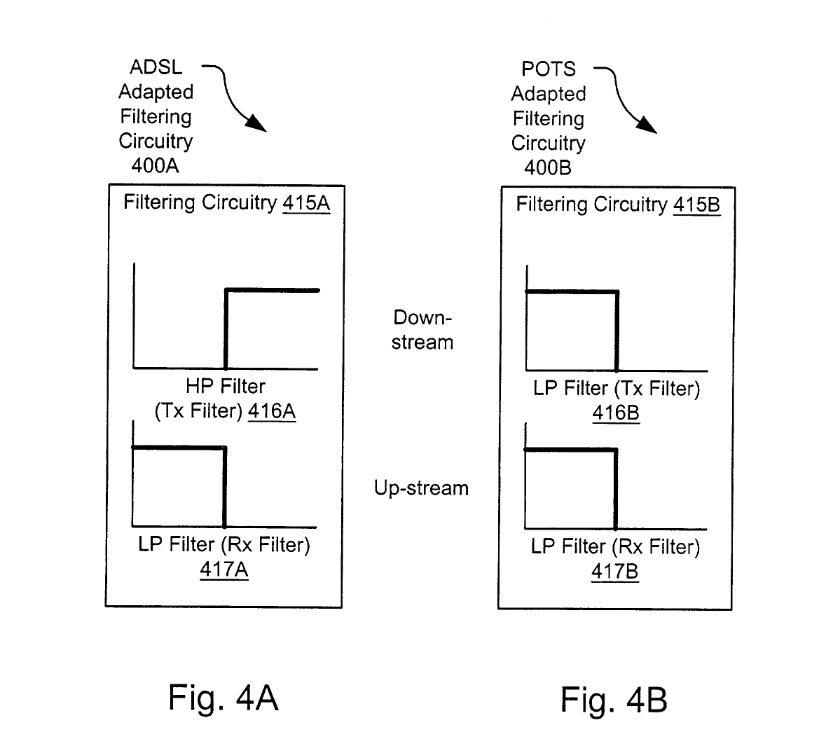

FIG. 4A is a system diagram illustrating an embodiment of asymmetric digital subscriber line (ADSL) adapted filtering circuitry 400A that is built in accordance with certain aspects of the invention. The asymmetric digital subscriber line (ADSL) adapted filtering circuitry 400A includes filtering circuitry 415A that performs the functionality of a high pass (HP) filter 416A for the down-stream or Tx path and that also performs the functionality of a low pass (LP) filter 417A for the up-stream or Rx path. The operation of the low pass (LP) filter 417A may also include the operation of splitting off a 4 kHz region for POTS at the DC end of the band when this portion has not been dealt with in preceding circuitry. When the 4 kHz region for POTS at the DC end of the band has already been dealt with, then the use of a simple LPF may be used. Those persons having skill in the art will recognize the functionality and the spectrum division of the filtering performed to accommodate asymmetric digital subscriber line (ADSL) services.

FIG. 4B is a system diagram illustrating an embodiment of plain old telephone service/system (POTS) adapted filtering circuitry 400B that is built in accordance with certain aspects of the invention. The plain old telephone service/system (POTS) adapted filtering circuitry 400B includes filtering circuitry 415B that performs the functionality of a low pass (LP) filter 416B for the down-stream or Tx path and that also performs the functionality of a low pass (LP) filter 417A for the up-stream or Rx path. In this embodiment of filtering that may be performed in accordance with certain aspects of the invention, the lower ends of the frequency band are the same for both the down-stream or Tx path and the up-stream or Rx path. This region of the frequency spectrum includes the 4 kHz region for POTS at the DC end of the band. Those persons having skill in the art will recognize the functionality and the spectrum division of the filtering performed to accommodate plain old telephone service/system (POTS) services.

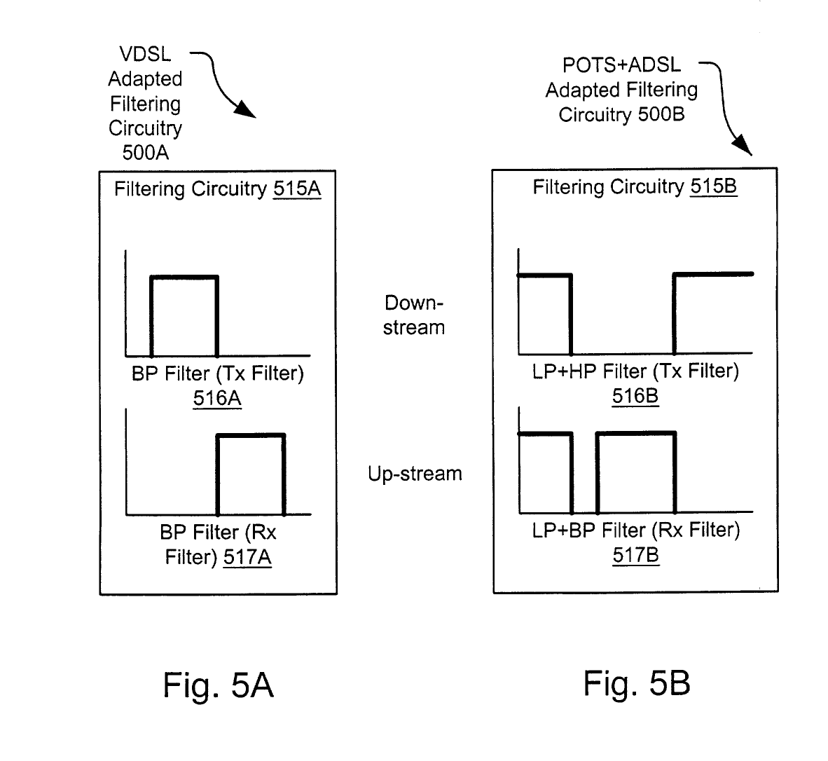

FIG. 5A is a system diagram illustrating an embodiment of very high speed asymmetric digital subscriber line (VDSL) adapted filtering circuitry 500A that is built in accordance with certain aspects of the invention. The very high speed asymmetric digital subscriber line (VDSL) adapted filtering circuitry 500A includes filtering circuitry 515A that performs the functionality of a band pass (BP) filter 516A for the down-stream or Tx path and that also performs the functionality of a band pass (BP) filter 517A for the up-stream or Rx path. In this embodiment of filtering that may be performed in accordance with certain aspects of the invention, the band pass (BP) filter 516A for the down-stream or Tx path operates using a lower end of the spectrum than the band pass (BP) filter 517A for the up-stream or Rx path. Those persons having skill in the art will recognize the functionality and the spectrum division of the filtering performed to accommodate very high speed asymmetric digital subscriber line (VDSL) services.

FIG. 5B is a system diagram illustrating an embodiment of plain old telephone system (POTS) and asymmetric digital subscriber line (ADSL) adapted filtering circuitry 500B that is built in accordance with certain aspects of the invention. The plain old telephone system (POTS) and asymmetric digital subscriber line (ADSL) adapted filtering circuitry 500B includes filtering circuitry 515B that performs the functionality of a low pass (LP) and high pass (HP) filter 516B for the down-stream or Tx path and that also performs the functionality of a low pass (LP) and a band pass (BP) filter 517B for the up-stream or Rx path. In this embodiment of filtering that may be performed in accordance with certain aspects of the invention, the low pass (LP) and high pass (HP) filter 516B for the down-stream or Tx path operates using a lower end of the spectrum than the band pass (BP) filter portion of the low pass (LP) and a band pass (BP) filter 517B for the up-stream or Rx path. In addition, the lower ends of the frequency spectrum captured by the low pass (LP) filter portions of the combination filters 516B and 517B are geared to the 4 kHz region for POTS at the DC end of the band. Those persons having skill in the art will recognize the functionality and the spectrum division of the filtering performed to accommodate both the plain old telephone system (POTS) and asymmetric digital subscriber line (ADSL) services in a single filtering circuitry.

Moreover, those persons having skill in the art will recognize the adaptability of the invention to accommodate filtering for any one, any combination, and/or all of the various services and networks proffered within various embodiments of the invention. These FIGS. 4A, 4B, 5A, and 5B are exemplary and not exhaustive, and one having skill in the art will understand, in light of the description within this patent application, that filtering may be extended to include such variations and permutations as required by particular applications. Moreover, the adaptability of the filtering may be adapted to accommodate services not yet envisioned, given the relative ease with which the filtering circuitry may be configured and modified, as also implemented using vacuum microelectronic circuitry within the various embodiments.

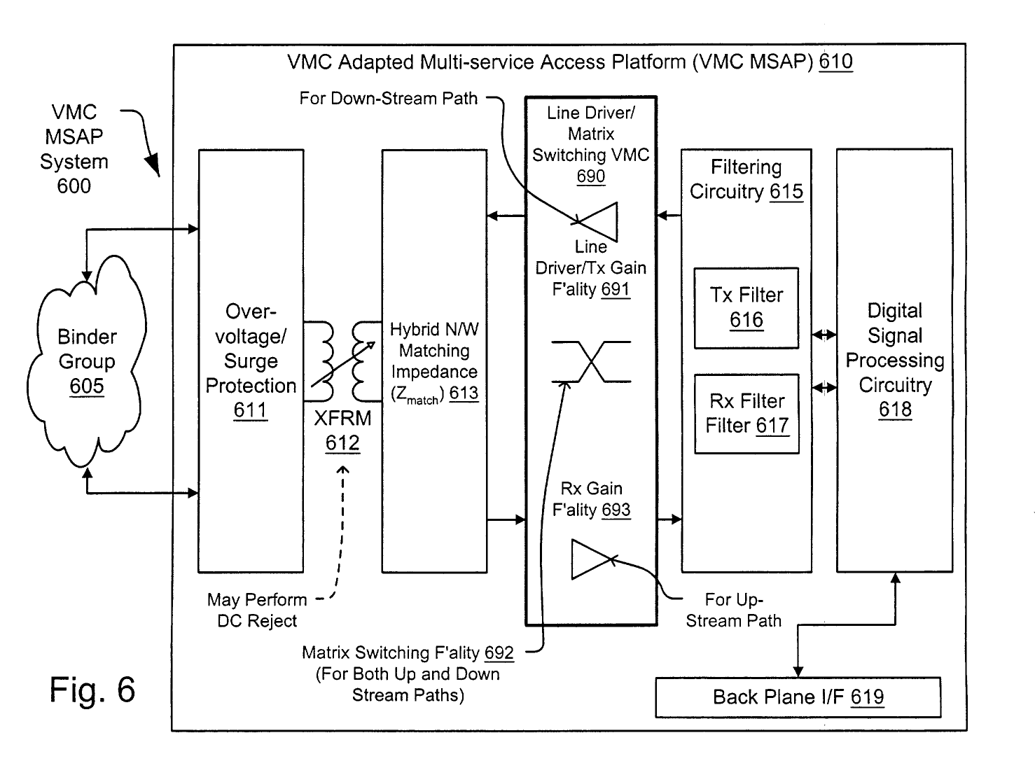

FIG. 6 is a system diagram illustrating an embodiment of a vacuum microelectronic circuitry multi-service access platform (MSAP) system 600 that is built in accordance with certain aspects of the invention. The MSAP system 600 includes a binder group 605 that may include a number of subscriber lines. The particular number of subscriber lines included within the binder group 605 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 610. From certain perspectives, the VMC MSAP 610 may be viewed as being located within a central office. Alternatively, it may be viewed as being within a digital loop carrier (DLC) in other embodiments.

The VMC MSAP 610 includes circuitry operable to perform over-voltage/surge protection 611. The functionality offered by the over-voltage/surge protection 611 includes lightning protection, protection from over-rated voltage getting on the system, and protection against surges of over-rated current as well. The over-voltage/surge protection 611 interfaces with a transformer (XFRM) 612. The XFRM 612 is operable to perform DC rejection of any of the inputs contained within the binder group 605. Alternatively, any requisite DC rejection or other filtering may also be performed in other areas within the VMC MSAP 610 as well.

The XFRM 612 interfaces with circuitry operable to provide a hybrid network matching impedance (Z_{match}) 613. The hybrid network matching impedance (Z_{match}) 613 is operable to perform impedance matching of the network to ensure maximum power and signal throughput, among other benefits of providing impedance matching between the network and the VMC MSAP 610. The hybrid network matching impedance (Z_{match}) 613 interfaces for both up-stream and down-stream throughput using a line driver/matrix switching VMC 690. The driver/matrix switching VMC 690 performs line driver/transmitter (Tx) gain functionality 691 and receiver (Rx) gain functionality 693 as well as matrix switching functionality 691. The matrix switch functionality 691 is operable to perform switching between the various subscribers and the various networks and services that they seek to solicit. The line driver/matrix switching VMC 690 is communicatively coupled to filtering circuitry 615. The filtering circuitry 615 is operable perform filtering for both the transmit (down-stream) and receive (up-stream) paths, as shown by a Tx filter 616 and a Rx filter 617. Moreover, the filtering circuitry 615 may also include an optional echo canceller. As mentioned above, and as will be described in even more detail below in various embodiments of the invention, the particular filtering that is to be performed for each of the potential services and networks that is to be accessed may various from application to application.

The filtering circuitry 615 communicatively couples to digital signal processing circuitry 640. The digital signal processing circuitry 640 then communicatively couples to a back plane interface (I/F) 619. The back plane interface (I/F) 619 is operable to communicatively couple to a network interface card or any other network interface circuitry that is operable to ensure that the VMC MSAP 610 is properly interfaced and communicatively coupled to a network. Alternatively, the back plane interface (I/F) 619 itself may be designed to include network interfacing circuitry, thereby obviating the need of an additional network interface card between the back plane interface (I/F) 619 and the network to which it is communicative coupling.

Similar to the embodiment described above in the FIG. 2, upon reviewing the various embodiments of the invention disclosed within this patent application, those persons having skill in the art will recognize that many of the various functionality devices within the VMC MSAP system 600 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

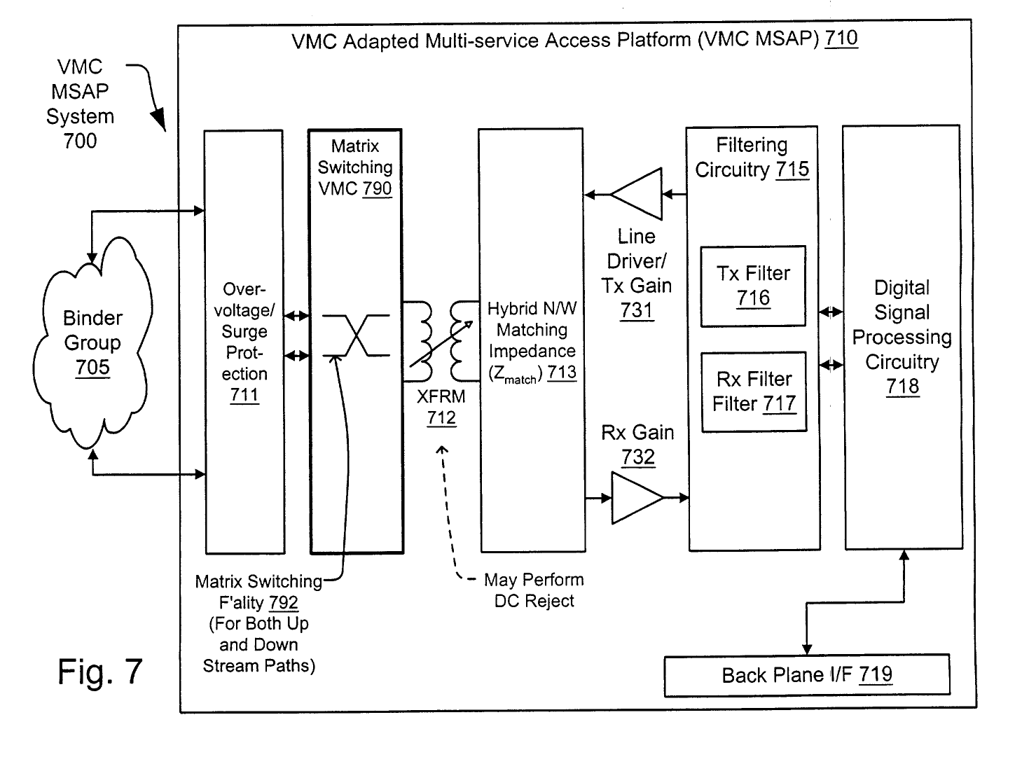

FIG. 7 is a system diagram illustrating an embodiment of a vacuum microelectronic circuitry multi-service access platform (MSAP) system 700 that is built in accordance with certain aspects of the invention. The MSAP system 700 includes a binder group 705 that may include a number of subscriber lines. The particular number of subscriber lines included within the binder group 705 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 710. From certain perspectives, the VMC MSAP 710 may be viewed as being located within a central office. Alternatively, it may be viewed as being within a digital loop carrier (DLC) in other embodiments.

The VMC MSAP 710 includes circuitry operable to perform over-voltage/surge protection 711. The functionality offered by the over-voltage/surge protection 711 includes lightning protection, protection from over-rated voltage getting on the system, and protection against surges of over-rated current as well. The over-voltage/surge protection 711 interfaces with a matrix switching vacuum microelectronic circuitry (VMC) 790. The matrix switching VMC 790 is configured to perform matrix switching functionality 792 for both up and down stream paths. The matrix switching vacuum microelectronic circuitry (VMC) 790 is communicatively coupled to a transformer (XFRM) 712. The XFRM 712 is operable to perform DC rejection of any of the inputs contained within the binder group 705. Alternatively, any requisite DC rejection or other filtering may also be performed in other areas within the VMC MSAP 710 as well.

The XFRM 712 interfaces with circuitry operable to provide a hybrid network matching impedance (Z_{match}) 713. The hybrid network matching impedance (Z_{match}) 713 is operable to perform impedance matching of the network to ensure maximum power and signal throughput, among other benefits of providing impedance matching between the network and the VMC MSAP 710. The hybrid network matching impedance (Z_{match}) 713 interfaces for both up-stream and down-stream throughput. The up-stream flow may be accommodated by a possible receiver (Rx) gain 732, and the down-stream flow is handled by a line driver/transmitter (Tx) gain 731. Each of the Rx gain 732 and the line driver/Tx gain 731 is communicatively coupled to filtering circuitry 715. The filtering circuitry 715 is operable perform filtering for both the transmit (down-stream) and receive (up-stream) paths, as shown by a Tx filter 716 and a Rx filter 717. Moreover, the filtering circuitry 715 may also include an optional echo canceller. As mentioned above, and as will be described in even more detail below in various embodiments of the invention, the particular filtering that is to be performed for each of the potential services and networks that is to be accessed may various from application to application. Each of the receiver (Rx) gain 732 and the line driver/transmitter (Tx) gain 731 communicatively couple to filtering circuitry 715. The filtering circuitry 715 is operable perform filtering for both the transmit (down-stream) and receive (up-stream) paths, as shown by a Tx filter 716 and a Rx filter 717. As mentioned above, and as will be described in even more detail below in various embodiments of the invention, the particular filtering that is to be performed for each of the potential services and networks that is to be accessed may various from application to application.

The filtering circuitry 715 communicatively couples to digital signal processing circuitry 740. The digital signal processing circuitry 740 then communicatively couples to a back plane interface (I/F) 719. The back plane interface (I/F) 719 is operable to communicatively couple to a network interface card or any other network interface circuitry that is operable to ensure that the VMC MSAP 710 is properly interfaced and communicatively coupled to a network. Alternatively, the back plane interface (I/F) 719 itself may be designed to include network interfacing circuitry, thereby obviating the need of an additional network interface card between the back plane interface (I/F) 719 and the network to which it is communicative coupling.

Similar to the embodiment described above in the FIGS. 2, 6, and 7, upon reviewing the various embodiments of the invention disclosed within this patent application, those persons having skill in the art will recognize that many of the various functionality devices within the VMC MSAP system 700 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

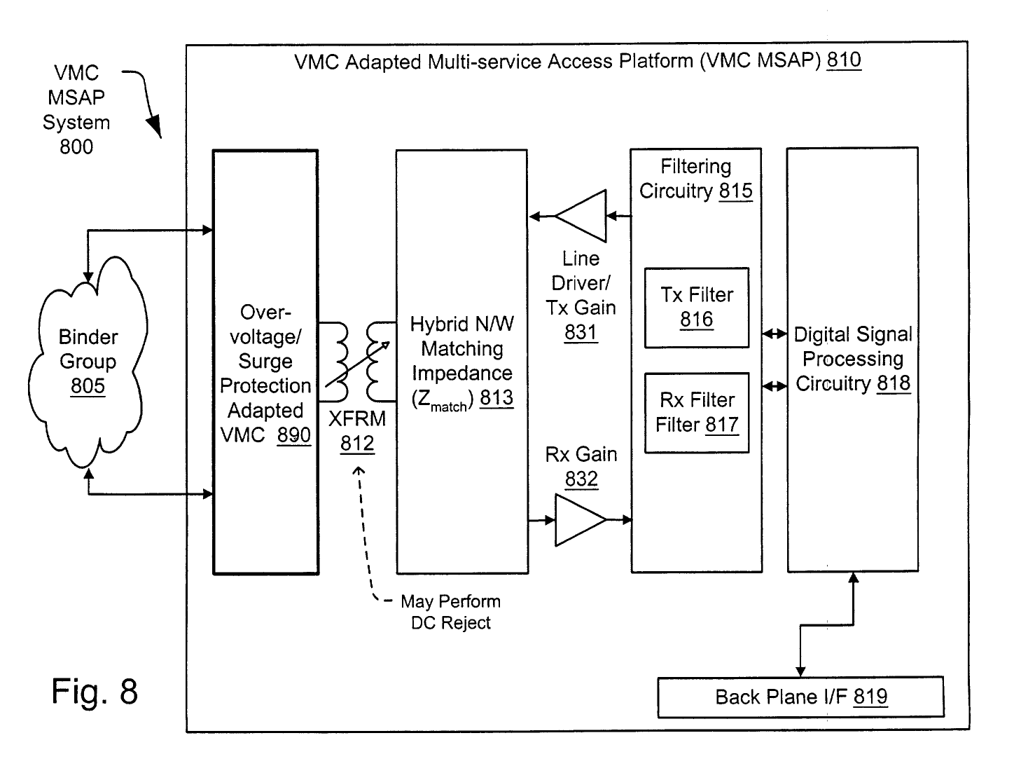

FIG. 8 is a system diagram illustrating another embodiment of a vacuum microelectronic circuitry multi-service access platform (MSAP) system 800 that is built in accordance with certain aspects of the invention. The MSAP system 800 includes a binder group 805 that may include a number of subscriber lines. The particular number of subscriber lines included within the binder group 805 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 810. From certain perspectives, the VMC MSAP 810 may be viewed as being located within a central office. Alternatively, it may be viewed as being within a digital loop carrier (DLC) in other embodiments.

The VMC MSAP 810 includes over-voltage/surge protection adapted vacuum microelectronic circuitry (VMC) 890. The functionality offered by the over-voltage/surge protection adapted VMC 890 includes lightning protection, protection from over-rated voltage getting on the system, and protection against surges of over-rated current as well. The over-voltage/surge protection adapted VMC 890 interfaces with a transformer (XFRM) 812. The XFRM 812 is operable to perform DC rejection of any of the inputs contained within the binder group 805. Alternatively, any requisite DC rejection or other filtering may also be performed in other areas within the VMC MSAP 810 as well.

The XFRM 812 interfaces with circuitry operable to provide a hybrid network matching impedance (Z_{match}) 813. The hybrid network matching impedance (Z_{match}) 813 is operable to perform impedance matching of the network to ensure maximum power and signal throughput, among other benefits of providing impedance matching between the network and the VMC MSAP 810. The hybrid network matching impedance (Z_{match}) 813 interfaces for both up-stream and down-stream throughput. The up-stream flow may be accommodated by a possible receiver (Rx) gain 832, and the down-stream flow is handled by a line driver/transmitter (Tx) gain 831. Each of the Rx gain 832 and the line driver/Tx gain 831 is communicatively coupled to filtering circuitry 815. The filtering circuitry 815 is operable perform filtering for both the transmit (down-stream) and receive (up-stream) paths, as shown by a Tx filter 816 and a Rx filter 817. Moreover, the filtering circuitry 815 may also include an optional echo canceller. As mentioned above, and as will be described in even more detail below in various embodiments of the invention, the particular filtering that is to be performed for each of the potential services and networks that is to be accessed may various from application to application. Each of the receiver (Rx) gain 832 and the line driver/transmitter (Tx) gain 831 communicatively couple to filtering circuitry 815. The filtering circuitry 815 is operable perform filtering for both the transmit (down-stream) and receive (up-stream) paths, as shown by a Tx filter 816 and a Rx filter 817. As mentioned above, and as will be described in even more detail below in various embodiments of the invention, the particular filtering that is to be performed for each of the potential services and networks that is to be accessed may various from application to application.

The filtering circuitry 815 communicatively couples to digital signal processing circuitry 840. The digital signal processing circuitry 840 then communicatively couples to a back plane interface (I/F) 819. The back plane interface (I/F) 819 is operable to communicatively couple to a network interface card or any other network interface circuitry that is operable to ensure that the VMC MSAP 810 is properly interfaced and communicatively coupled to a network. Alternatively, the back plane interface (I/F) 819 itself may be designed to include network interfacing circuitry, thereby obviating the need of an additional network interface card between the back plane interface (I/F) 819 and the network to which it is communicative coupling.

Similar to the embodiment described above in the FIGS. 2, 6, and 7, upon reviewing the various embodiments of the invention disclosed within this patent application, those persons having skill in the art will recognize that many of the various functionality devices within the VMC MSAP system 800 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

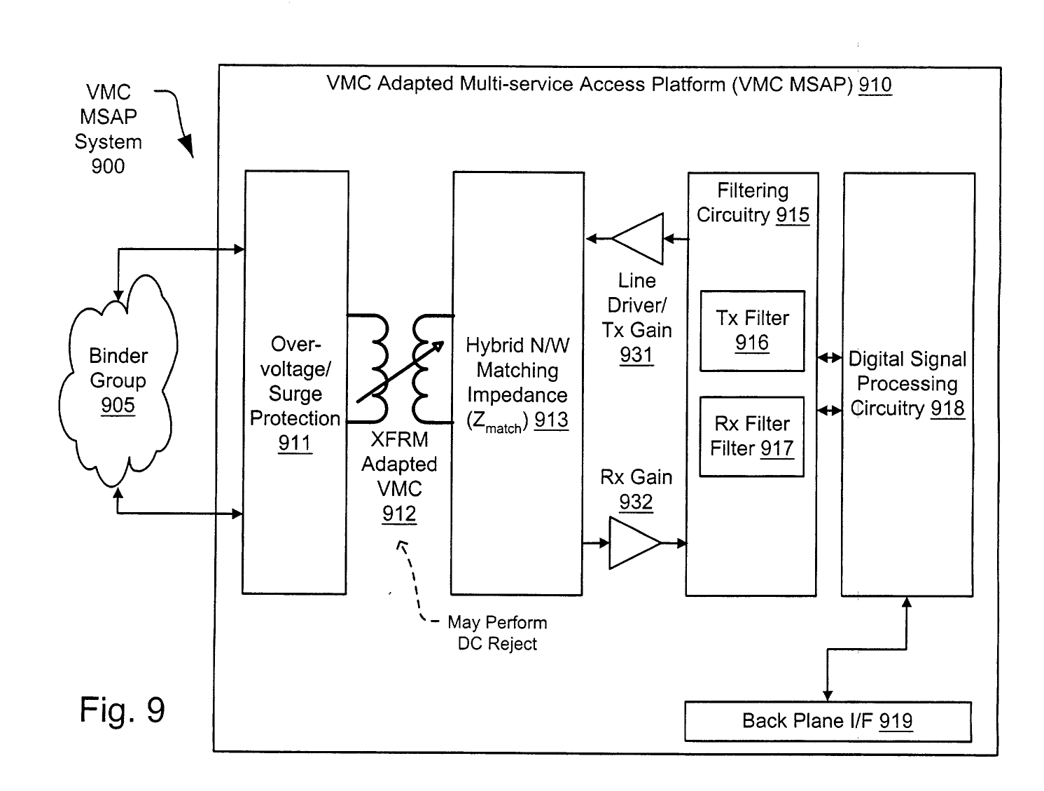

FIG. 9 is a system diagram illustrating another embodiment of a vacuum microelectronic circuitry multi-service access platform (MSAP) system 900 that is built in accordance with certain aspects of the invention. The MSAP system 900 includes a binder group 905 that may include a number of subscriber lines. The particular number of subscriber lines included within the binder group 905 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 910. From certain perspectives, the VMC MSAP 910 may be viewed as being located within a central office. Alternatively, it may be viewed as being within a digital loop carrier (DLC) in other embodiments.

The VMC MSAP 910 includes circuitry operable to perform over-voltage/surge protection 911. The functionality offered by the over-voltage/surge protection 911 includes lightning protection, protection from over-rated voltage getting on the system, and protection against surges of over-rated current as well. The over-voltage/surge protection 911 interfaces with a transformer adapted vacuum microelectronic circuitry (XFRM VMC) 912. The XFRM VMC 912 is operable to perform DC rejection of any of the inputs contained within the binder group 905. Alternatively, any requisite DC rejection or other filtering may also be performed in other areas within the VMC MSAP 910 as well.

The XFRM VMC 912 interfaces with circuitry operable to provide a hybrid network matching impedance (Z_{match}) 913. The hybrid network matching impedance (Z_{match}) 913 is operable to perform impedance matching of the network to ensure maximum power and signal throughput, among other benefits of providing impedance matching between the network and the VMC MSAP 910. The hybrid network matching impedance (Z_{match}) 913 interfaces for both upstream and down-stream throughput. The up-stream flow may be accommodated by a possible receiver (Rx) gain 932, and the down-stream flow is handled by a line driver/transmitter (Tx) gain 931. Each of the Rx gain 932 and the line driver/Tx gain 931 is communicatively coupled to filtering circuitry 915. The filtering circuitry 915 is operable perform filtering for both the transmit (down-stream) and receive (up-stream) paths, as shown by a Tx filter 916 and a Rx filter 917. Moreover, the filtering circuitry 915 may also include an optional echo canceller. As mentioned above, and as will be described in even more detail below in various embodiments of the invention, the particular filtering that is to be performed for each of the potential services and networks that is to be accessed may various from application to application. Each of the receiver (Rx) gain 932 and the line driver/transmitter (Tx) gain 931 communicatively couple to filtering circuitry 915. The filtering circuitry 915 is operable perform filtering for both the transmit (down-stream) and receive (up-stream) paths, as shown by a Tx filter 916 and a Rx filter 917. As mentioned above, and as will be described in even more detail below in various embodiments of the invention, the particular filtering that is to be performed for each of the potential services and networks that is to be accessed may various from application to application.

The filtering circuitry 915 communicatively couples to digital signal processing circuitry 940. The digital signal processing circuitry 940 then communicatively couples to a back plane interface (I/F) 919. The back plane interface (I/F) 919 is operable to communicatively couple to a network interface card or any other network interface circuitry that is operable to ensure that the VMC MSAP 910 is properly interfaced and communicatively coupled to a network. Alternatively, the back plane interface (I/F) 919 itself may be designed to include network interfacing circuitry, thereby obviating the need of an additional network interface card between the back plane interface (I/F) 919 and the network to which it is communicative coupling.

Similar to the embodiment described above in the FIGS. 2, 6 7, and 8, upon reviewing the various embodiments of the invention disclosed within this patent application, those persons having skill in the art will recognize that many of the various functionality devices within the VMC MSAP system 900 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

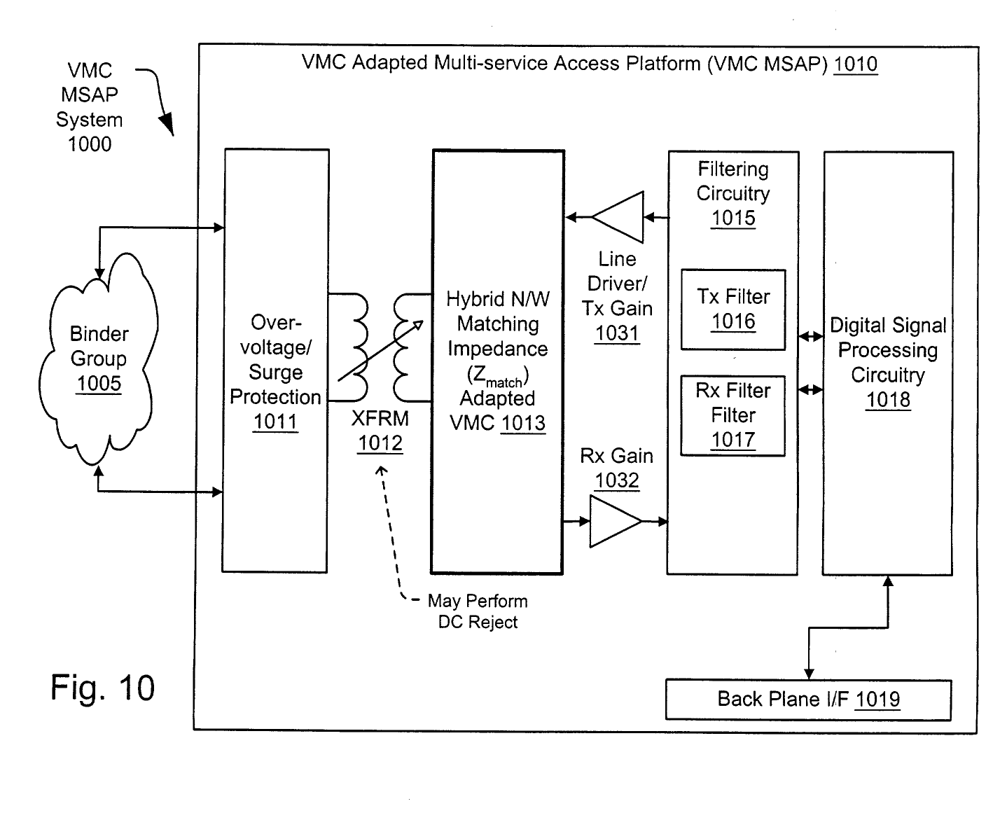

FIG. 10 is a system diagram illustrating another embodiment of a vacuum microelectronic circuitry multi-service access platform (MSAP) system that is built in accordance with certain aspects of the invention. The MSAP system 1000 includes a binder group 1005 that may include a number of subscriber lines. The particular number of subscriber lines included within the binder group 1005 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 1010. From certain perspectives, the VMC MSAP 1010 may be viewed as being located within a central office. Alternatively, it may be viewed as being within a digital loop carrier (DLC) in other embodiments.

The VMC MSAP 1010 includes circuitry operable to perform over-voltage/surge protection 1011. The functionality offered by the over-voltage/surge protection 1011 includes lightning protection, protection from over-rated voltage getting on the system, and protection against surges of over-rated current as well. The over-voltage/surge protection 1011 interfaces with a transformer (XFRM) 1012. The XFRM 1012 is operable to perform DC rejection of any of the inputs contained within the binder group 1005. Alternatively, any requisite DC rejection or other filtering may also be performed in other areas within the VMC MSAP 1010 as well.

The XFRM 1012 interfaces with hybrid network matching impedance (Z_{match}) adapted vacuum microelectronic circuitry (VMC) 1013. The hybrid network matching impedance (Z_{match}) adapted VMC 1013 is operable to perform impedance matching of the network to ensure maximum power and signal throughput, among other benefits of providing impedance matching between the network and the VMC MSAP 1010. The hybrid network matching impedance (Z_{match}) adapted VMC 1013 interfaces for both up-stream and down-stream throughput. The upstream flow may be accommodated by a possible receiver (Rx) gain 1032, and the down-stream flow is handled by a line driver/transmitter (Tx) gain 1031. Each of the Rx gain 1032 and the line driver/Tx gain 1031 is communicatively coupled to filtering circuitry 1015. The filtering circuitry 1015 is operable perform filtering for both the transmit (down-stream) and receive (upstream) paths, as shown by a Tx filter 1016 and a Rx filter 1017. Moreover, the filtering circuitry 1015 may also include an optional echo canceller. As mentioned above, and as will be described in even more detail below in various embodiments of the invention, the particular filtering that is to be performed for each of the potential services and networks that is to be accessed may various from application to application. Each of the receiver (Rx) gain 1032 and the line driver/transmitter (Tx) gain 1031 communicatively couple to filtering circuitry 1015. The filtering circuitry 1015 is operable perform filtering for both the transmit (down-stream) and receive (up-stream) paths, as shown by a Tx filter 1016 and a Rx filter 1017. As mentioned above, and as will be described in even more detail below in various embodiments of the invention, the particular filtering that is to be performed for each of the potential services and networks that is to be accessed may various from application to application.

The filtering circuitry 1015 communicatively couples to digital signal processing circuitry 1040. The digital signal processing circuitry 1040 then communicatively couples to a back plane interface (I/F) 1019. The back plane interface (I/F) 1019 is operable to communicatively couple to a network interface card or any other network interface circuitry that is operable to ensure that the VMC MSAP 1010 is properly interfaced and communicatively coupled to a network. Alternatively, the back plane interface (I/F) 1019 itself may be designed to include network interfacing circuitry, thereby obviating the need of an additional network interface card between the back plane interface (I/F) 1019 and the network to which it is communicative coupling.

Similar to the embodiment described above in the FIGS. 2, 6, 7, 8, and 9, upon reviewing the various embodiments of the invention disclosed within this patent application, those persons having skill in the art will recognize that many of the various functionality devices within the VMC MSAP system 1000 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

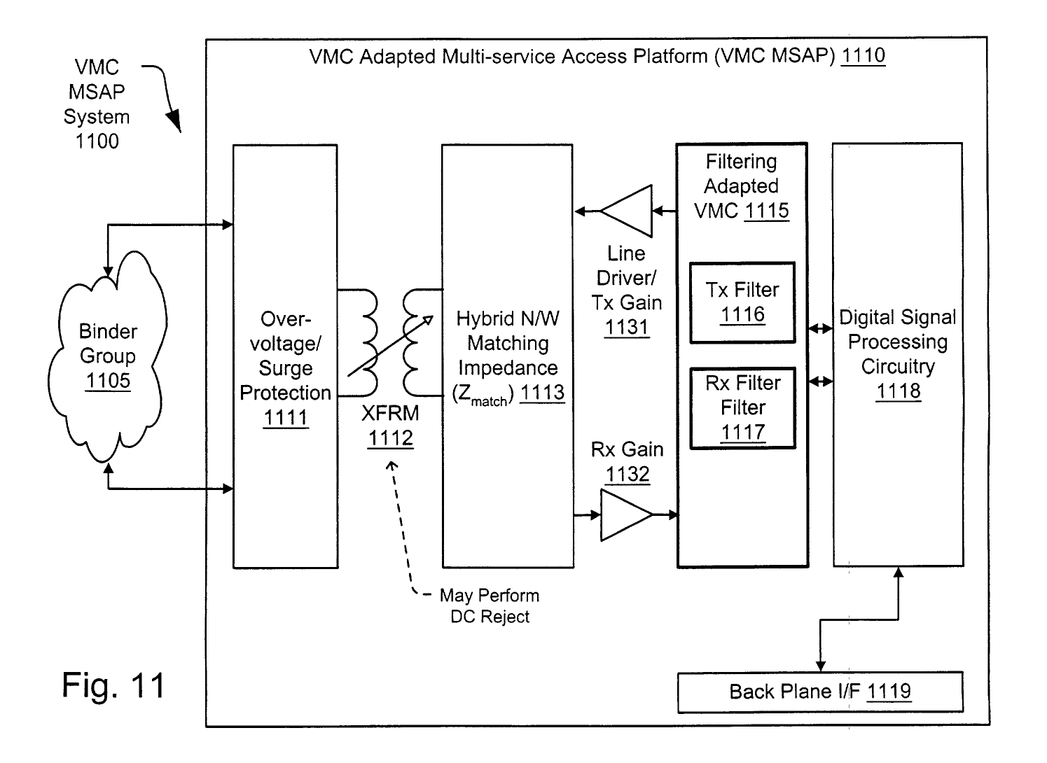

FIG. 11 is a system diagram illustrating another embodiment of a vacuum microelectronic circuitry multi-service access platform (MSAP) system that is built in accordance with certain aspects of the invention. The MSAP system 1100 includes a binder group 11 05 that may include a number of subscriber lines. The particular number of subscriber lines included within the binder group 1105 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 1110. From certain perspectives, the VMC MSAP 1110 may be viewed as being located within a central office. Alternatively, it may be viewed as being within a digital loop carrier (DLC) in other embodiments.

The VMC MSAP 11 10 includes circuitry operable to perform over-voltage/surge protection 1111. The functionality offered by the over-voltage/surge protection 1111 includes lightning protection, protection from over-rated voltage getting on the system, and protection against surges of over-rated current as well. The over-voltage/surge protection 1111 interfaces with a transformer (XFRM) 1112. The XFRM 1112 is operable to perform DC rejection of any of the inputs contained within the binder group 1105. Alternatively, any requisite DC rejection or other filtering may also be performed in other areas within the VMC MSAP 1110 as well.

The XFRM 1112 interfaces with a circuitry that is operable to provide a hybrid network matching impedance (Z_{match}) 1113. The hybrid network matching impedance (Z_{match}) 1113 is operable to perform impedance matching of the network to ensure maximum power and signal throughput, among other benefits of providing impedance matching between the network and the VMC MSAP 1110. The hybrid network matching impedance (Z_{match}) 1113 interfaces for both up-stream and down-stream throughput. The up-stream flow may be accommodated by a possible receiver (Rx) gain 1132, and the down-stream flow is handled by a line driver/transmitter (Tx) gain 1131. Each of the Rx gain 1132 and the line driver/Tx gain 1131 is communicatively coupled to filtering adapted vacuum microelectronic circuitry (VMC) 1115. The filtering adapted VMC 1115 is configured to provide functionality to perform filtering for both the transmit (down-stream) and receive (up-stream) paths, as shown by a Tx filter 1116 and a Rx filter 1117. Moreover, the filtering adapted VMC 1115 may also be configured to perform the optional functionality of an echo canceller. As mentioned above, and as will be described in even more detail below in various embodiments of the invention, the particular filtering that is to be performed for each of the potential services and networks that is to be accessed may various from application to application. Each of the receiver (Rx) gain 1132 and the line driver/transmitter (Tx) gain 1131 communicatively couple to filtering circuitry 1115. The filtering circuitry 1115 is operable perform filtering for both the transmit (down-stream) and receive (up-stream) paths, as shown by a Tx filter 1116 and a Rx filter 1117. As mentioned above, and as will be described in even more detail below in various embodiments of the invention, the particular filtering that is to be performed for each of the potential services and networks that is to be accessed may various from application to application.

The filtering circuitry 11 15 communicatively couples to digital signal processing circuitry 1140. The digital signal processing circuitry 1140 then communicatively couples to a back plane interface (I/F) 1119. The back plane interface (I/F) 1119 is operable to communicatively couple to a network interface card or any other network interface circuitry that is operable to ensure that the VMC MSAP 1110 is properly interfaced and communicatively coupled to a network. Alternatively, the back plane interface (I/F) 1119 itself may be designed to include network interfacing circuitry, thereby obviating the need of an additional network interface card between the back plane interface (I/F) 1119 and the network to which it is communicative coupling.

Similar to the embodiment described above in the FIGS. 2, 6, 7, 8, 9, and 10, upon reviewing the various embodiments of the invention disclosed within this patent application, those persons having skill in the art will recognize that many of the various functionality devices within the VMC MSAP system 1100 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

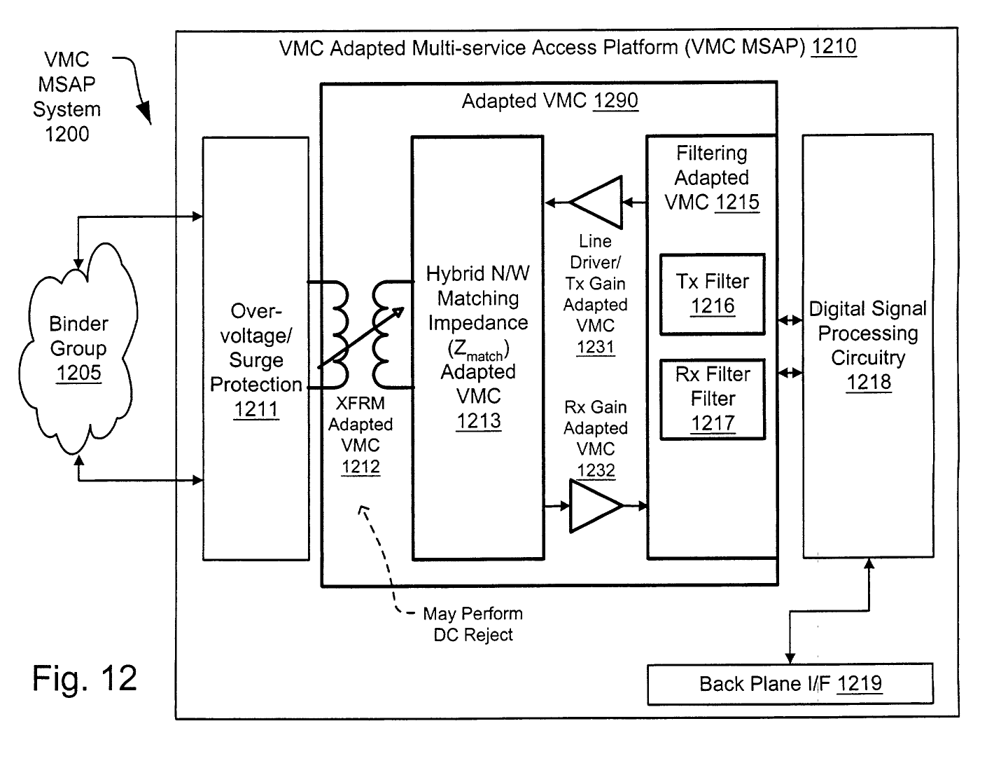

FIG. 12 is a system diagram illustrating another embodiment of a vacuum microelectronic circuitry multi-service access platform (MSAP) system that is built in accordance with certain aspects of the invention. The MSAP system 1200 includes a binder group 1205 that may include a number of subscriber lines. The particular number of subscriber lines included within the binder group 1205 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 1210. From certain perspectives, the VMC MSAP 1210 may be viewed as being located within a central office. Alternatively, it may be viewed as being within a digital loop carrier (DLC) in other embodiments. Moreover, an entire portion of the VMC MSAP 1210 is composed of adapted vacuum microelectronic circuitry (VMC) 1290.

The VMC MSAP 1210 includes circuitry operable to perform over-voltage/surge protection 1211. The functionality offered by the over-voltage/surge protection 1211 includes lightning protection, protection from over-rated voltage getting on the system, and protection against surges of over-rated current as well. The over-voltage/surge protection 1211 interfaces with a transformer adapted vacuum microelectronic circuitry (XFRM VMC) 1212. The XFRM VMC 1212 is operable to perform DC rejection of any of the inputs contained within the binder group 1205. Alternatively, any requisite DC rejection or other filtering may also be performed in other areas within the VMC MSAP 1210 as well.

The XFRM VMC 1212 interfaces with hybrid network matching impedance (Z_{match}) adapted vacuum microelectronic circuitry (VMC) 1213. The hybrid network matching impedance (Z_{match}) adapted VMC 1213 is operable to perform impedance matching of the network to ensure maximum power and signal throughput, among other benefits of providing impedance matching between the network and the VMC MSAP 1210. The hybrid network matching impedance (Z_{match}) adapted VMC 1213 interfaces for both up-stream and down-stream throughput. The up-stream flow may be accommodated by a possible receiver (Rx) gain adapted VMC 1232, and the down-stream flow is handled by a line driver/transmitter (Tx) gain adapted VMC 1231. Each of the Rx gain adapted VMC 1232 and the line driver/Tx gain adapted VMC 1231 is communicatively coupled to filtering adapted vacuum microelectronic circuitry (VMC) 1215. The filtering adapted VMC 1215 is configured to provide functionality to perform filtering for both the transmit (down-stream) and receive (up-stream) paths, as shown by a Tx filter 1216 and a Rx filter 1217. Moreover, the filtering adapted VMC 1215 may also be configured to perform the optional functionality of an echo canceller. As mentioned above, and as will be described in even more detail below in various embodiments of the invention, the particular filtering that is to be performed for each of the potential services and networks that is to be accessed may various from application to application. Each of the receiver (Rx) gain 1232 and the line driver/transmitter (Tx) gain 1231 communicatively couple to filtering circuitry 1215. The filtering circuitry 1215 is operable perform filtering for both the transmit (down-stream) and receive (up-stream) paths, as shown by a Tx filter 1216 and a Rx filter 1217. As mentioned above, and as will be described in even more detail below in various embodiments of the invention, the particular filtering that is to be performed for each of the potential services and networks that is to be accessed may various from application to application.

The filtering circuitry 1215 communicatively couples to digital signal processing circuitry 1240. The digital signal processing circuitry 1240 then communicatively couples to a back plane interface (I/F) 1219. The back plane interface (I/F) 1219 is operable to communicatively couple to a network interface card or any other network interface circuitry that is operable to ensure that the VMC MSAP 1210 is properly interfaced and communicatively coupled to a network. Alternatively, the back plane interface (I/F) 1219 itself may be designed to include network interfacing circuitry, thereby obviating the need of an additional network interface card between the back plane interface (I/F) 1219 and the network to which it is communicative coupling.

Similar to the embodiment described above in the FIGS. 2, 6, 7, 8, 9, 10, and 11, upon reviewing the various embodiments of the invention disclosed within this patent application, those persons having skill in the art will recognize that many of the various functionality devices within the VMC MSAP system 1200 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

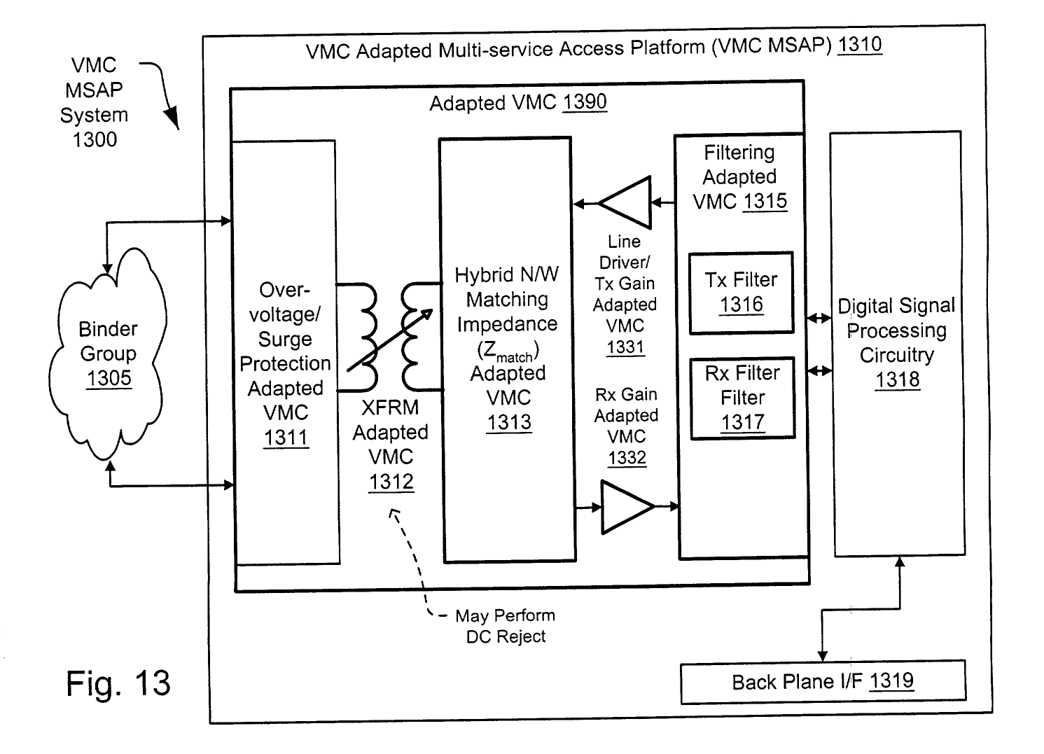

FIG. 13 is a system diagram illustrating another embodiment of a vacuum microelectronic circuitry multi-service access platform (MSAP) system that is built in accordance with certain aspects of the invention. The MSAP system 1300 includes a binder group 1305 that may include a number of subscriber lines. The particular number of subscriber lines included within the binder group 1305 is variable in certain instances, and the scalability of the invention is operable to accommodate any of the various number of subscriber lines. The binder group is shown as interfacing with a vacuum microelectronic circuitry (VMC) adapted multi-service access platform (VMC MSAP) 1310. From certain perspectives, the VMC MSAP 1310 may be viewed as being located within a central office. Alternatively, it may be viewed as being within a digital loop carrier (DLC) in other embodiments. Moreover, an entire portion of the VMC MSAP 1310 is composed of adapted vacuum microelectronic circuitry (VMC) 1390.

The VMC MSAP 1310 includes over-voltage/surge protection adapted vacuum microelectronic circuitry (VMC) 1311. The over-voltage/surge protection adapted VMC 1311 includes lightning protection, protection from over-rated voltage getting on the system, and protection against surges of over-rated current as well. The over-voltage/surge protection adapted VMC 1311 interfaces with a transformer adapted vacuum microelectronic circuitry (XFRM VMC) 1312. The XFRM VMC 1312 is operable to perform DC rejection of any of the inputs contained within the binder group 1305. Alternatively, any requisite DC rejection or other filtering may also be performed in other areas within the VMC MSAP 1310 as well.

The XFRM VMC 1312 interfaces with hybrid network matching impedance (Z_{match}) adapted vacuum microelectronic circuitry (VMC) 1313. The hybrid network matching impedance (Z_{match}) adapted VMC 1313 is operable to perform impedance matching of the network to ensure maximum power and signal throughput, among other benefits of providing impedance matching between the network and the VMC MSAP 1310. The hybrid network matching impedance (Z_{match}) adapted VMC 1313 interfaces for both up-stream and down-stream throughput. The up-stream flow may be accommodated by a possible receiver (Rx) gain adapted VMC 1332, and the down-stream flow is handled by a line driver/transmitter (Tx) gain adapted VMC 1331. Each of the Rx gain adapted VMC 1332 and the line driver/Tx gain adapted VMC 1331 is communicatively coupled to filtering adapted vacuum microelectronic circuitry (VMC) 1315. The filtering adapted VMC 1315 is configured to provide functionality to perform filtering for both the transmit (down-stream) and receive (up-stream) paths, as shown by a Tx filter 1316 and a Rx filter 1317. Moreover, the filtering adapted VMC 1315 may also be configured to perform the optional functionality of an echo canceller. As mentioned above, and as will be described in even more detail below in various embodiments of the invention, the particular filtering that is to be performed for each of the potential services and networks that is to be accessed may various from application to application. Each of the receiver (Rx) gain 1332 and the line driver/transmitter (Tx) gain 1331 communicatively couple to filtering circuitry 1315. The filtering circuitry 1315 is operable perform filtering for both the transmit (down-stream) and receive (up-stream) paths, as shown by a Tx filter 1316 and a Rx filter 1317. As mentioned above, and as will be described in even more detail below in various embodiments of the invention, the particular filtering that is to be performed for each of the potential services and networks that is to be accessed may various from application to application.

The filtering circuitry 1315 communicatively couples to digital signal processing circuitry 1340. The digital signal processing circuitry 1340 then communicatively couples to a back plane interface (I/F) 1319. The back plane interface (I/F) 1319 is operable to communicatively couple to a network interface card or any other network interface circuitry that is operable to ensure that the VMC MSAP 1310 is properly interfaced and communicatively coupled to a network. Alternatively, the back plane interface (I/F) 1319 itself may be designed to include network interfacing circuitry, thereby obviating the need of an additional network interface card between the back plane interface (I/F) 1319 and the network to which it is communicative coupling.

Similar to the embodiment described above in the FIGS. 2, 6, 7, 8, 9, 10, 11, and 12, upon reviewing the various embodiments of the invention disclosed within this patent application, those persons having skill in the art will recognize that many of the various functionality devices within the VMC MSAP system 1300 may be transposed without departing from the scope and spirit of the invention. For example, the over-voltage/surge protection may be provided immediately before interfacing with any digital signal processing circuitry in various embodiments of the invention. The variations of moving and re-ordering such transposable devices does not depart from the scope and spirit of the invention.

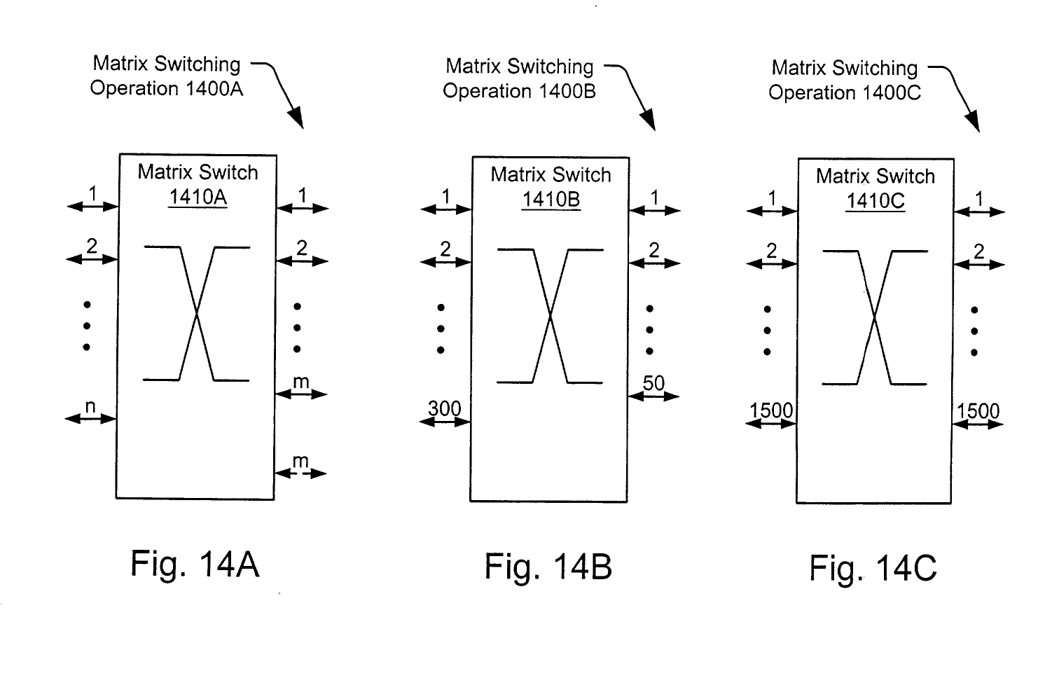

FIG. 14A is a functional block diagram illustrating an embodiment matrix switching operation that 1400A is performed in accordance with certain aspects of the invention. A matrix switch 1410A is shown as being operable to perform switching between an indefinite number of inputs 1, 2, . . . , and n to an indefinite number of outputs 1, 2, . . . , and m. The number of outputs m may differ from the number of inputs n. In addition, the number of outputs m may be less than the number of inputs n; the number of outputs m may be also be greater than the number of inputs n (as shown by the dotted line to the optional output m). The matrix switch 1410A may be employed in any of the various embodiments of the invention shown above. In addition as also shown above in many of the various embodiments, the matrix switch 1410A may also be employed within the different locations within the various embodiments shown above. The indefinite number of inputs n and outputs m is shown, among other reasons, to display the adaptability of the switching functionality of the matrix switch 1410A and its ability to be adapted to any number of applications.

FIG. 14B is a functional block diagram illustrating an embodiment matrix switching operation 1400B that is performed in accordance with certain aspects of the invention. From certain perspectives, the matrix switch 1400B is one of the particular embodiments of the matrix switch 1400A as shown above in the FIG. 14A. The FIG. 14B shows one embodiment of matrix switching operation that is ideally tailored to application within any of the multi-service access platforms described above in the various embodiments of the invention. For example, as shown above, the matrix switch functionality may be located in any number of the various locations within the various embodiments without departing from the scope and spirit of the invention. However, from at least one perspective, the matrix switch 1400B is appropriately chosen in terms of input to output to accommodate the needs and requirements of a binder group, containing any number of subscriber lines, in terms of the physical limits within a central office including considerations such as cross-talk, board impedance, trace impedance, and other considerations relating to the performance and layout of a number of subscriber lines coming into a central office having a fixed size and processing capabilities. The scalability of the matrix switching functionality employed within the invention is theoretically indefinite, as described in the FIG. 14A, yet the invention is also adaptable to situations where the physical constraints of a given application present limits such as the number of lines and the number of devices that may be employed within a particular application.

As shown in the FIG. 14B, a matrix switch 1410B is shown as being operable to perform switching between a number of inputs 1, 2, . . . , and 300 to a number of outputs 1, 2, . . . , and 50. The number of outputs is 300, and the number of inputs is 50. This 300×50 switching matrix size is appropriately chosen and is operable to meet a particular number of design requirements within the digital subscriber line (DSL) context.

FIG. 14C is a functional block diagram illustrating an embodiment matrix switching operation 1400C that is performed in accordance with certain aspects of the invention. From certain perspectives, the matrix switch 1400C is one of the particular embodiments of the matrix switch 1400A as shown above in the FIG. 14A. The FIG. 14C shows one embodiment of matrix switching operation that is operable using one of any number of commercially available vacuum microelectronic circuitry products. Some products are operable to perform 1500×1500 matrix switching. While this total number of operable switching may be viewed as being overkill in certain embodiments of the invention, the availability of such matrix switching may be fully utilized in different embodiments.

As shown in the FIG. 14B, a matrix switch 1410B is shown as being operable to perform switching between a number of inputs 1, 2, . . . , and 1500 to an identical number of outputs 1, 2, . . . , and 15000. The number of outputs is 1500, and the number of inputs is 1500. This 1500×1500 switching matrix size is just one such sized and available vacuum microelectronic circuitry product device.

Moreover, the availability of such high density vacuum microelectronic circuitry allows operation for a number of applications. For example, a re-configured or adapted vacuum microelectronic circuitry could be generated to include various functionality offered by the inherent anode-cathode characteristics offered within the vacuum microelectronic circuitry for any number of applications including over-voltage/surge protection, hybrid network matching impedance (Z_{match}), line driver functionality, gain and voltage stepping functionality, filtering functionality, and of course matrix switching. The invention has disclosed many embodiments that employ the configurable nature of such vacuum microelectronic circuitry within such applications besides simply matrix switching. If desired, the high density of gas chambers allowed within these vacuum microelectronic circuitry devices are operable to perform one, all, or combinations of these various functions without departing from the scope and spirit of the invention. As desired within a particular application, the total number of functions that are implemented within the vacuum microelectronic circuitry will vary, yet the scope and spirit of the invention includes each of these various permutations. Many of these permutations have been shown explicitly, yet those having skill in the art will recognize the ability of this design to be easily extended to such other embodiments as well.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A multi-service access platform, comprising:
an over-voltage/surge protection circuitry;
a transformer, communicatively coupled to the over-voltage/surge protection circuitry;
a matching network impedance circuitry, communicatively coupled to the transformer;
a line driver/down-stream gain amplifier, communicatively coupled to the matching network impedance circuitry;
an up-stream gain amplifier that is also communicatively coupled to the matching network impedance circuitry; and
a filtering circuitry, communicatively coupled to the line driver/down-stream gain amplifier and the up-stream gain amplifier, that is operable to perform filtering of up and down stream throughputs; and
wherein at least one of the over-voltage/surge protection circuitry, the transformer, the line driver/down-stream gain amplifier, the up-stream gain amplifier, and a portion of the filtering circuitry is implemented using vacuum microelectronic circuitry.

2. The multi-service access platform of claim 1, wherein a combination of two circuitries is implemented using vacuum microelectronic circuitry; and
wherein the combination of two circuitries is selected from a group consisting of the over-voltage/surge protection circuitry, the transformer, the line driver/down-stream gain amplifier, the up-stream gain amplifier, and a portion of the filtering circuitry.

3. The multi-service access platform of claim 1, wherein the multi-service access platform is operable to perform network interfacing with at least one of a public switch(ed) telephone network, a private Internet protocol network, a voice over Internet protocol network, and the Internet.

4. The multi-service access platform of claim 1, wherein the multi-service access platform is contained within a central office.

5. The multi-service access platform of claim 4, wherein the central office further comprises a digital signal processing circuitry.

6. The multi-service access platform of claim 5, wherein the digital signal processing circuitry further comprises at least one of a plain old telephone system digital signal processing circuitry, an asymmetric digital subscriber line digital signal processing circuitry, a very high speed asymmetric digital subscriber line digital signal processing circuitry, an integrated services digital network digital signal processing circuitry, and a T1 digital signal processing circuitry.

7. The multi-service access platform of claim 6, wherein at least one of plain old telephone system digital signal processing circuitry, the asymmetric digital subscriber line digital signal processing circuitry, the very high speed asymmetric digital subscriber line digital signal processing circuitry, the integrated services digital network digital signal processing circuitry, and the T1 line digital signal processing circuitry comprises a dedicated analog to digital converter and a dedicated digital to analog converter.

8. The multi-service access platform of claim 6, wherein the filtering circuitry is operable to perform filtering for at least one application selected from a group consisting of a plain old telephone system application, an asymmetric digital subscriber line application, a very high speed asymmetric digital subscriber line application, an integrated services digital network application, and a T1 line application.

9. The multi-service access platform of claim 4, wherein the central office comprises at least one additional vacuum microelectronic circuitry, disposed external to the multi-service access platform; and
the at least one additional vacuum microelectronic circuitry is configured to perform matrix switching functionality.

10. The multi-service access platform of claim 1, wherein the vacuum microelectronic circuitry is configured to perform matrix switching functionality.

11. A subscriber network, comprising:
a subscriber line;
a network; and
a central office that interfaces with the subscriber line and provides connectivity between the subscriber line and the network; and
wherein at least a portion of circuitry within the central office comprises vacuum microelectronic circuitry.

12. The subscriber network of claim 11, wherein the central office further comprises a multi-service access platform.

13. The subscriber network of claim 12, wherein the multi-service access platform further comprises:
an over-voltage/surge protection circuitry;
a transformer, communicatively coupled to the over-voltage/surge protection circuitry;
a matching network impedance circuitry, communicatively coupled to the transformer;
a line driver/down-stream gain amplifier, communicatively coupled to the matching network impedance circuitry;
an up-stream gain amplifier that is also communicatively coupled to the matching network impedance circuitry; and
a filtering circuitry, communicatively coupled to the line driver/down-stream gain amplifier and the up-stream gain amplifier, that is operable to perform filtering of up and down stream throughputs.

14. The subscriber network of claim 13, wherein the filtering circuitry is operable to perform filtering for at least one application selected from a group consisting of a plain old telephone system application, an asymmetric digital subscriber line application, a very high speed asymmetric digital subscriber line application, an integrated services digital network application, and a T1 line application.

15. The subscriber network of claim 13, wherein the multi-service access platform is operable to perform network interfacing with at least one of a public switch(ed) telephone network, a private Internet protocol network, a voice over Internet protocol network, and the Internet.

16. The subscriber network of claim 11, wherein the vacuum microelectronic circuitry is configured to perform matrix switching functionality.

17. The subscriber network of claim 11, wherein the vacuum microelectronic circuitry is configured to perform matrix switching functionality; and
the vacuum microelectronic circuitry communicatively couples the over-voltage/surge protection circuitry and the transformer.

18. A multi-service access platform, comprising:
an over-voltage/surge protection circuitry;
a transformer, communicatively coupled to the over-voltage/surge protection circuitry;
a matching network impedance circuitry, communicatively coupled to the transformer;
a vacuum microelectronic circuitry that is configured to perform line driver/down-stream gain amplifier functionality, up-stream gain amplifier functionality, and matrix switching functionality that is also communicatively coupled to the matching network impedance circuitry, the vacuum microelectronic circuitry is communicatively coupled to a matching network impedance circuitry; and
a filtering circuitry, communicatively coupled to the line driver/down-stream gain amplifier and the up-stream gain amplifier, that is operable to perform filtering of up and down stream throughputs.

19. A multi-service access platform, comprising:
an over-voltage/surge protection circuitry;
a vacuum microelectronic circuitry, communicatively coupled to the over-voltage/surge protection circuitry, that is operable to perform matrix switching functionality;
a transformer, communicatively coupled to the vacuum microelectronic circuitry;
a matching network impedance circuitry, communicatively coupled to the transformer;
a line driver/down-stream gain amplifier, communicatively coupled to the matching network impedance circuitry;
an up-stream gain amplifier that is also communicatively coupled to the matching network impedance circuitry; and
a filtering circuitry, communicatively coupled to the line driver/down-stream gain amplifier and the up-stream gain amplifier, that is operable to perform filtering of up and down stream throughputs.

20. A multi-service access platform, comprising:
an over-voltage/surge protection circuitry;
a transformer adapted vacuum microelectronic circuitry, communicatively coupled to the over-voltage/surge protection circuitry;
a matching network impedance adapted vacuum microelectronic circuitry, communicatively coupled to the transformer adapted vacuum microelectronic circuitry;
a line driver/down-stream gain amplifier adapted vacuum microelectronic circuitry, communicatively coupled to the matching network impedance adapted vacuum microelectronic circuitry;
an up-stream gain amplifier adapted vacuum microelectronic circuitry that is also communicatively coupled to the matching network impedance adapted vacuum microelectronic circuitry; and
a filtering circuitry adapted vacuum microelectronic circuitry, communicatively coupled to the line driver/down-stream gain amplifier adapted vacuum microelectronic circuitry and the up-stream gain amplifier adapted vacuum microelectronic circuitry, that is operable to perform filtering of up and down stream throughputs.
